(19) United States
(12) Patent Application Publication
(10) Pub. No.: US 2025/0349283 A1
(43) Pub. Date: Nov. 13, 2025

(54) TRAINING SPEECH RECOGNITION MODEL, AND SPEECH RECOGNITION

(71) Applicant: MASHANG CONSUMER FINANCE CO., LTD., Chongqing (CN)

(72) Inventor: Qinglin MENG, Chongqing (CN)

(73) Assignee: MASHANG CONSUMER FINANCE CO., LTD., Chongqing (CN)

(21) Appl. No.: 18/919,078

(22) Filed: Oct. 17, 2024

(30) Foreign Application Priority Data
May 8, 2024 (CN) 202410569237.5

(51) Int. Cl. G10L 15/06; G10L 15/02; G10L 15/08; G10L 15/18

(52) U.S. Cl. CPC G10L 15/063; G10L 15/02; G10L 15/1815; G10L 2015/088

(57) ABSTRACT

A method of training a speech recognition model includes: determining a reference word for first speech data and a hot word label for the reference word; performing fusion processing on a word feature of the reference word and an acoustic feature of the first speech data to obtain a fused feature vector; performing hot word prediction based on the fused feature vector to obtain a hot word prediction result for the first speech data and performing speech recognition based on the fused feature vector to obtain a predicted text for the first speech data, by the speech recognition model; and training the speech recognition model based on the hot word prediction result, the hot word label, and the predicted text.

### CROSS-REFERENCE TO RELATED APPLICATION

This application claims priority to and the benefit of Chinese Patent Application No. 202410569237.5, filed on May 8, 2024, the disclosure of which is incorporated herein by reference in its entirety.

### TECHNICAL FIELD

The present disclosure relates to speech processing technologies, and more particularly, to training of a speech recognition model, and speech recognition.

### BACKGROUND

Generally, for end-to-end speech recognition, deep networks may have greater generalization capabilities. On the other hand, an end-to-end speech recognition model is often suitable for recognize an object in word units, which is different from a hybrid model using phonemes as modeling units. Therefore, the end-to-end speech recognition model is more dependent on training data, and the semantic information carried by the recognized object is more likely to tend to the training data.

However, there is less training data containing certain specific words, such as hot words in certain service scenarios, and thus a speech recognition model trained thereby cannot accurately recognize the specific words and, when applied to the certain service scenarios, may result in an inaccurate speech recognition result.

### SUMMARY

According to one or more embodiments of the present disclosure, a method for training a speech recognition model includes: determining a reference word for first speech data and a hot word label for the reference word; performing fusion processing on a word feature of the reference word and an acoustic feature of the first speech data to obtain a fused feature vector; performing hot word prediction based on the fused feature vector to obtain a hot word prediction result for the first speech data and performing speech recognition based on the fused feature vector to obtain a predicted text for the first speech data, by the speech recognition model; and training the speech recognition model based on the hot word prediction result, the hot word label, and the predicted text.

According to one or more embodiments of the present disclosure, a speech recognition method includes: obtaining target speech data and a target hot word; performing fusion processing on a word feature of the target hot word and an acoustic feature of the target speech data to obtain a target fused feature vector; and performing speech recognition on the target fused feature vector, by a speech recognition model trained according to the above method, to obtain a target predicted text for the target speech data.

According to one or more embodiments of the present disclosure, an electronic device includes: a processor; and a memory storing instructions executable by the processor to perform the above method of training the speech recognition model or the above speech recognition method.

According to one or more embodiments of the present disclosure, a non-transitory computer-readable storage medium stores instructions executable by a processor of an electronic device to perform the above method of training the speech recognition model or the above speech recognition method.

According to one or more embodiments of the present disclosure, a computer program product includes a non-transitory computer-readable storage medium storing a computer program executable by a computer to perform the above method of training the speech recognition model or the above speech recognition method.

### BRIEF DESCRIPTION OF THE DRAWINGS

FIG. 1 is a schematic flowchart of an example of a method of training a speech recognition model according to one or more embodiments of the present disclosure.

FIG. 2 schematically illustrates a fusion process on the basis of an attention mechanism according to one or more embodiments of the present disclosure.

FIG. 3 is a schematic flowchart of another example of a method of training a speech recognition model according to one or more embodiments of the present disclosure.

FIG. 4 is a schematic flowchart of an example of a speech recognition method according to one or more embodiments of the present disclosure.

FIG. 5 is a schematic flowchart of another example of a speech recognition method according to one or more embodiments of the present disclosure.

FIG. 6 is a schematic block diagram of an apparatus for training a speech recognition model according to one or more embodiments of the present disclosure.

FIG. 7 is a schematic block diagram of a speech recognition apparatus according to one or more embodiments of the present disclosure.

FIG. 8 is a schematic block diagram of an electronic device according to one or more embodiments of the present disclosure.

FIG. 9 is a schematic flowchart of steps of determining a reference word and a hot word label according to one or more embodiments of the present disclosure.

FIG. 10 is a schematic flowchart of steps of fusion processing according to one or more embodiments of the present disclosure.

FIG. 11 is a schematic flowchart of steps of performing the block attention operation according to one or more embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

The terms “first”, “second”, etc. in this specification and claims are used to distinguish similar objects and are not used to describe a particular order or sequence. It should be understood that the data so used may be interchanged, where appropriate, so that embodiments of the present disclosure can be implemented in an order other than those illustrated or described herein. In addition, “and/or” in this specification and in the claims denotes at least one of the connected objects, and the character “/” generally indicates that the objects associated with each other are in an “or” relationship.

Description of some concepts:

End-to-end speech recognition: the purpose of speech recognition is to convert vocabulary content in human speech into text content. End-to-end speech recognition uses a neural network-only instead such as a conventional traditional hybrid and separate training pattern of alignment models, acoustic models, and language models.

Transformer: a timing model based on a self-attention mechanism. The timing information may be efficiently encoded in the encoder part, and the capability of processing the timing information thereof is much better than that of the long short-term memory (LSTM), and the speed of processing the timing information thereof is faster. The transformer is widely used in fields such as natural language processing, computer vision, machine translation, speech recognition, and the like.

Conformer: a model combining transformer and convolutional neural networks (CNN). The transformer is good at capturing content-based global interactions, while the CNN effectively utilizes local features so that the conformer has better modeling of both long-term global interaction information and local features.

Connectionist temporal classification (CTC): the CTC is a loss function in the timing labeling problem. The conventional sequence labeling algorithm requires an input symbol and an output symbol to be fully aligned at each moment, while the CTC extends the tag set to add an empty element. After the sequence is labeled with an extended tag set, all prediction sequences that may be converted into real sequences by a mapping function are correct predictions. That is, the prediction sequence may be obtained without data alignment processing.

Hot words: the hot words refer to words that often appear in a desired speech recognition scenario, but appear less in training data, and often appear in a specific scenario.

One or more embodiments of the present disclosure provide a method for training a speech recognition model, a speech recognition method, and related devices, which may accurately recognize hot words in various scenarios, thereby improving the accuracy of speech recognition.

It should be understood that the training method and the speech recognition method of the speech recognition model according to one or more embodiments of the present disclosure may be performed by an electronic device. The electronic device referred to herein may include terminal devices such as smartphones, tablets, notebook computers, desktop computers, intelligent speech interaction devices, smart home appliances, smart watches, in-vehicle terminals, aircraft, and the like. Alternatively, the electronic device may further include a server, such as a separate physical server, a server cluster or a distributed system composed of a plurality of physical servers, or a cloud server providing a cloud computing service. The electronic device is independent of the back-end server.

It should be noted that the speech recognition method according to one or more embodiments of the present disclosure may be applied to various service scenarios. As an example, the speech recognition method may be applied to an anti-fraud scenario. For the anti-fraud scenario, there is less training data including hot words such as “fraud”, “low interest”, “fast money transfer”, “unsecured” and the like. On the other hand, the recognition effect by the end-to-end speech recognition models depends on the training data. Therefore, the speech recognition model trained using traditional training methods cannot accurately recognize such hot words, resulting in inaccurate speech recognition results.

With a speech recognition model trained based on the training method according to one or more embodiments of the present disclosure, even if there is only a limited amount of training data containing the hot words, information similar to the hot words can be accurately captured from speech data. Thus, hot word information can be accurately captured from the speech data in the anti-fraud scenario and then applied to the speech recognition process, so that highly accurate predicted text can be output.

In this way, during the conversation with the user end, the following process of operations may be performed: receiving speech data input by the user in real time; inputting the word features of the hot words in the anti-fraud scenario and the acoustic features of the speech data into the trained speech recognition model to obtain a predicted text for the speech data; performing intention recognition on the predicted text to obtain a predicted intention, thereby determining whether the user has an intention of fraud; generating a reply text based on the predicted intention, and converting the reply text into reply speech data; and returning the reply speech data to the user end, thereby completing a round of reply. This process is repeated until the conversation with the user end is terminated.

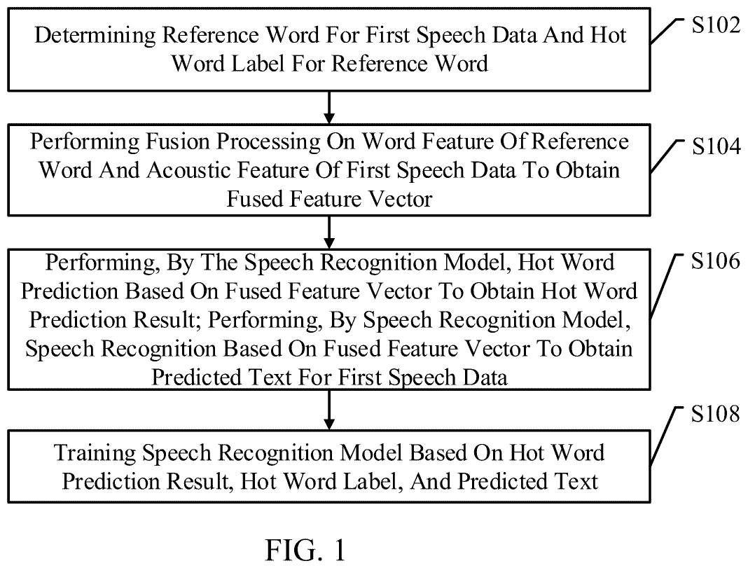

FIG. 1 is a schematic flowchart of a method of training a speech recognition model according to one or more embodiments of the present disclosure. The method may include Step S102, Step S104, Step S106, and Step S108.

At Step S102, a reference word for first speech data and a hot word label for the reference word are determined.

The first speech data may include a portion of speech data extracted from a speech data set. The speech data set includes a plurality of pieces of preset speech data, each piece of speech data having one of annotation texts. The annotation text may be obtained by artificial recognition of the speech data corresponding to the annotation text. The annotation text is used to provide a supervisory signal to the speech recognition model during training to instruct the speech recognition model to learn how to convert the speech data into the correct text.

In a specific implementation, the training process for the speech recognition model includes multiple rounds of training. As an example, during each round of training, a specified number of speech data are randomly extracted from the speech data set to obtain a plurality of pieces of first speech data for the round of training.

The hot word label for the reference word is used to indicate the type of reference word, such as a hot word or a non-hot word.

In an implementation, the reference word may include a portion of the word determined from the annotation text for the first speech data.

In another implementation, the reference word may include a pre-collected word associated with an application scenario of the speech recognition model.

In still another implementation, Step S102 includes: Step S121, performing text extraction on the annotation text for the speech data included in the speech data set to obtain the reference word of the first speech data; and Step S122, determining the hot word label for the reference word based on the annotation text for the first speech data.

As an example, at Step S121, one or more words are randomly extracted from the annotation text for the speech data included in the speech data set as the reference word of the first speech data. At Step S122, the hot word label for the reference word is determined based on whether the reference word matches the one or more words in the annotation text for the first speech data.

For example, a start index and the number of words of the annotation texts to be extracted are preset as a text extraction range. Then, within the text extraction range, words are randomly extracted from the annotation texts of all the pieces of speech data included in the speech data set as the reference words. Then, for each reference word, it is determined whether this reference word matches a word in the annotation text for the first speech data. In response to determining that this reference word matches the word in the annotation text for the first speech data, this reference word is determined as the hot word, and further a hot word label indicating the hot word is set for this reference word. In response to determining that this reference word does not match the word in the annotation text for the first speech data, this reference word is determined as a non-hot word, and a hot word label indicating the non-hot word is set for this reference word.

In practical applications, to prevent the length of the reference word from being too long to exceed the limit, thereby affecting the capturing capability of the speech recognition model for the hot word, a length threshold value of the extracted word may further be set in the text extraction range to ensure that the length of the extracted word is within a range defined by the length threshold value.

In an implementation, from the annotation text for all the pieces of speech data of the original speech data set, the reference word for the first speech data is extracted and the hot word label for the reference word is determined, the hot word information contained in these data is more universal, and may guide the voice recognition model to capture similar hot word information as much as possible, to improve the hot word capture capability of the voice recognition model in various scenarios.

The embodiments of the present disclosure herein illustrate some implementations of Step S102 described above. It should be understood that the above-described Step S102 may be implemented in other ways, and the embodiment of the present disclosure is not limited thereto.

At Step S104, fusion processing is performed on a word feature of the reference word and an acoustic feature of the first speech data to obtain a fused feature vector.

The word feature of the reference word may include, but are not limited to, an index of each character of the reference word in a dictionary, a position of each character of the reference word, and/or the like, which are not limited in the presented embodiments of the present disclosure. The word feature of the reference words may be obtained by performing feature extraction on the reference words.

The acoustic feature of the first speech data may selected from various acoustic features such as fbank features. The acoustic feature of the first speech data may be obtained by various acoustic feature extraction techniques. As an example, the fbank feature may be obtained as an acoustic feature of the first speech data by performing pre-emphasis, framing, windowing, discrete Fourier transform, Mel filtering, or the like on the first speech data.

By fusing the word feature of the reference word and the acoustic feature of the first speech data, the hot word information of the first speech data and the acoustic feature are effectively fused in a fused feature vector. The above-described fusion process may be carried out in various proper ways, and may be selected according to actual needs.

In an implementation, the above-described Step S104 includes: concatenating the word feature of the reference word and the acoustic feature of the first speech data to obtain the fused feature vector.

In an implementation, the above-described Step S104 includes: determining a query matrix based on the word feature of the reference word, determining a key matrix and a value matrix based on the acoustic feature of the first speech data, and attentively calculating the query matrix, the key matrix and the value matrix based on the attention mechanism to obtain a fused feature vector.

In the present embodiment, the attention mechanism is configured to fuse the word feature and the acoustic feature, which is similar to a form of looking up a dictionary. For example, with the word feature as a reference, the acoustic information corresponding to the hot word information is queried in the acoustic feature, so that the word feature and the acoustic feature may be better fused together, thereby improving the hot word prediction effect of the speech recognition model.

In yet another embodiment, the above-described Step S104 includes Step S141 and Step S142.

At Step S141, a block attention operation is performed on the word feature of the reference word and the acoustic feature of the first speech data to obtain an operation result.

As an example, in the above Step S141, a first query matrix is determined based on the word feature of the reference word, a first key matrix and a first value matrix are determined based on the acoustic feature of the first speech data, and the block attention operation is performed according to the first query matrix, the first key matrix and the first value matrix to obtain an operation result. The block attention operation indicates an operation of dividing the query matrix, the key matrix, and the value matrix respectively into X query matrices, the X key matrices, and X value matrices; grouping the X key matrices, the X value matrices, and the X query matrices into a plurality of matrix sets each including one of the X key matrices, one of the X value matrices, and one of the X query matrices, and performing an attention operation on each matrix set. Where X is an integer greater than one.

Specifically, the performing of the block attention operation according to the first query matrix, the first key matrix and the first value matrix to obtain the operation result includes Step A1, Step A2, Step A3, and Step A4.

At Step A1, the first query matrix is divided into N sub-query matrices. N is an integer greater than 1.

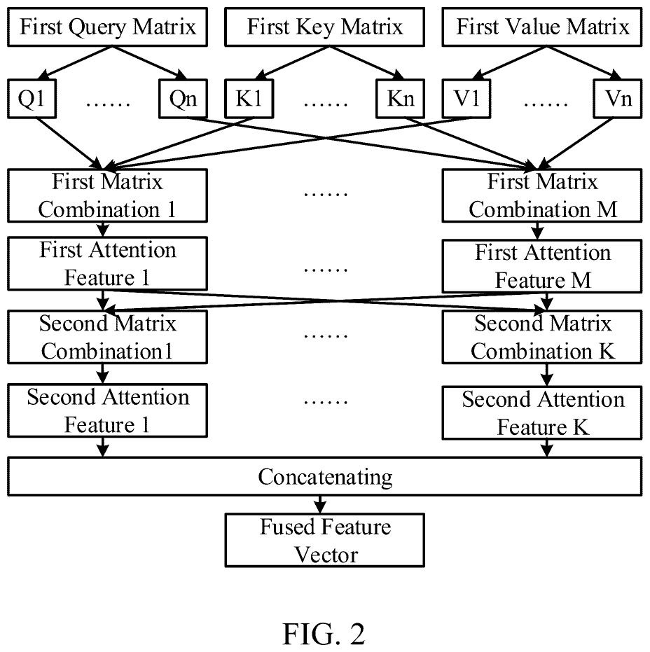

For example, as shown in FIG. 2, the word feature of the reference word is encoded to obtain a word representation vector. Then, the word representation vector is used as the first query (Query) matrix, and the first query matrix is divided into N sub-query matrices, i.e., Q1 to Qn, according to a specified block size. In practical applications, the block size may be used as a super-parameter and trained with the speech recognition model.

At Step A2, the first key matrix is divided into N sub-key matrices, and the first value matrix is divided into N sub-value matrices.

For example, as shown in FIG. 2, the acoustic feature is encoded to obtain an acoustic representation vectors. Then, the acoustic representation vectors are used as the first key (Key) matrix and the first value (Value) matrix, respectively, and then the first key matrix is divided into N sub-key matrices, i.e., K1 to Kn, and the first value matrix is divided into N sub-value matrices, i.e., V1 to Vn, according to a specified block size. In practical applications, the block size may be used as a super-parameter and trained with the speech recognition model.

At Step A3, the N sub-query matrices, the N sub-key matrices, and the N sub-value matrices are grouped to obtain M first matrix sets.

Each first matrix set includes one sub-query matrix, one sub-key matrix, and one sub-value matrix, and M is an integer greater than N.

For example, assuming that the N sub-query matrices include sub-query matrices Q1 and Q2, the N sub-key matrices include sub-key matrices K1 and K2, and the N sub-value matrices include sub-value matrices V1 and V2. The following eight first matrix sets may be obtained by grouping the above matrices Q1, Q2, K1, K2, V1, and V2: {Q1, K1, V1}, {Q1, K1, V2}, {Q1, K2, V1}, {Q1, K2, V2}, {Q2, K1, V1}, {Q2, K1, V2}, {Q2, K2, K2, V1}, {Q2, K2, K2, V2}.

At Step A4, for each first matrix set, an attention operation is performed on the first matrix set to obtain a first attention feature of the first matrix set, and the respective first attention features of the M first matrix sets is added to obtain the operation result.

The operation result includes the first attention features of the M first matrix sets. In an embodiment, the attention operation performed on the first matrix set may include a cross attention operation.

As an example, for each first matrix set, the first attention feature of the first matrix set may be obtained by performing the attention operation as follows:

$$Attention ( Q , K , V ) = Softmax ( \frac{Q {K}^{T}}{\sqrt{{d}_{k}}} ) V , \qquad ( 1 )$$

where Attention(Q, K, V) represents a first attention feature of the first matrix set, Q represents a sub-query matrix in the first matrix set, K represents a sub-key matrix in the first matrix set, K^{T} represents a transposed matrix of the sub-key matrix, V represents a sub-value matrix in the first matrix set, dₖ represents a dimension of the sub-value matrix, and Softmax represents a normalized exponential function for performing an attention operation.

At Step S142, a cross attention operation is performed based on the operation result to obtain the fused feature vector. Specifically, as shown in FIG. 2, the M second query matrices, the M second key matrices, and the M second value matrices are determined based on the first attention features of the M first matrix sets. The M second query matrices, the M second key matrices, and the M second value matrices are grouped to obtain K second matrix sets. Each second matrix set includes one of the second query matrices, one of the second key matrices, and one of the second value matrices. K is an integer greater than M. For each second matrix set, the cross attention operation is performed on the second matrix set to obtain a second attention feature of the second matrix set. The second attention features of the K second matrix sets are concatenated to obtain a fused feature vector.

For example, for each first attention feature, the first attention feature is used as one second query matrix, one second key matrix, and one second value matrix. Thus, based on the first attention features of the M first matrix sets, M second query matrices, M second key matrices, and M second value matrices are obtained. The second query matrix, the second key matrix, and the second value matrix are grouped to obtain K second matrix sets. Then, for each second matrix set, the cross attention operation is performed on the second query matrix, the second key matrix, and the second value matrix to obtain a second attention feature of the second matrix set. The second attention features of all the second matrix sets are concatenated, to obtain a fused feature vector.

In an implementation of the present disclosure, when the word feature of the reference word is too greater, the word feature and the acoustic feature is directly fused in the conventional attention mechanism, so that the attention of the speech recognition model will be dispersed, and the hot word prediction effect will be deteriorated. In view of this, the technical concept of block expansion is adopted. First, the first query matrix, the first key matrix, and the first value matrix are block-divided, respectively, and attention operation is performed on each of the block-divided sub-query matrix, the block-divided sub-key matrix, and the block-divided sub-value matrix. Since the size of each matrix is reduced in the attention operation, attention may be more concentrated, and further, hot word information may be more accurately captured from an excessive word features when processing the word feature, thereby preventing attention dispersion. In addition, in view of the fact that the hot word information may not be captured completely due to the lack of close information between the preceding text and the following text after the block-divided operation, the hot word prediction effect is further affected. Therefore, by performing fusion processing on all the first attention features obtained by after the block-divided operation, the connection between the preceding text and the following text information in the word features is made closer, thereby facilitating the speech recognition model to capture the complete hot word information and improving the hot word prediction effect.

Embodiments of the present disclosure herein illustrate some embodiments of Step S104 described above. It should be understood that the above-mentioned Step S104 may be implemented in other ways, and the embodiments of the present disclosure are not limited thereto.

At Step S104, the performing of the fusion processing on the word feature of the reference word includes: directly fusing the original word feature and the original acoustic feature, or first encoding the word feature and the acoustic feature and then fusing the word representation vector and the acoustic representation vector obtained from the encoding. For the latter, the fusion of the word feature and the acoustic feature is more effective, and the attention to the hot word information in the fused feature vector may be further increased.

For the latter fusion method, to better fuse the hot word information into the encoding process of the speech recognition model to enhance the generalization effect of the speech recognition model, at Step S104, the word feature is encoded by the speech recognition model to obtain a word representation vector, multi-stage encoding is performed on the acoustic features by the speech recognition model to obtain a first acoustic representation vector for each level of encoding, and performing fusion processing on the first target acoustic representation vector and the word representation vector to obtain a fused feature vector. The first target acoustic representation vector refers to a first acoustic representation vector for the target level encoding that satisfies a first selection condition in the multilevel encodings. The first selection condition may be set according to actual requirements. For example, the last stage coding is selected as a target level coding, and the first acoustic representation vector encoded by the last stage coding is used as the first target acoustic representation vector. The embodiments of the present disclosure are not limited thereto.

For example, a word feature is two-level encoded by the speech recognition model, a vector obtained by the two-level encodings is used as a word representation vector, and an acoustic feature is eight-level encoded by the speech recognition model to obtain the first acoustic representation vectors respectively for eight levels. The fused feature vector is obtained by fusing the first acoustic representation vector for the eighth level and the word representation vector.

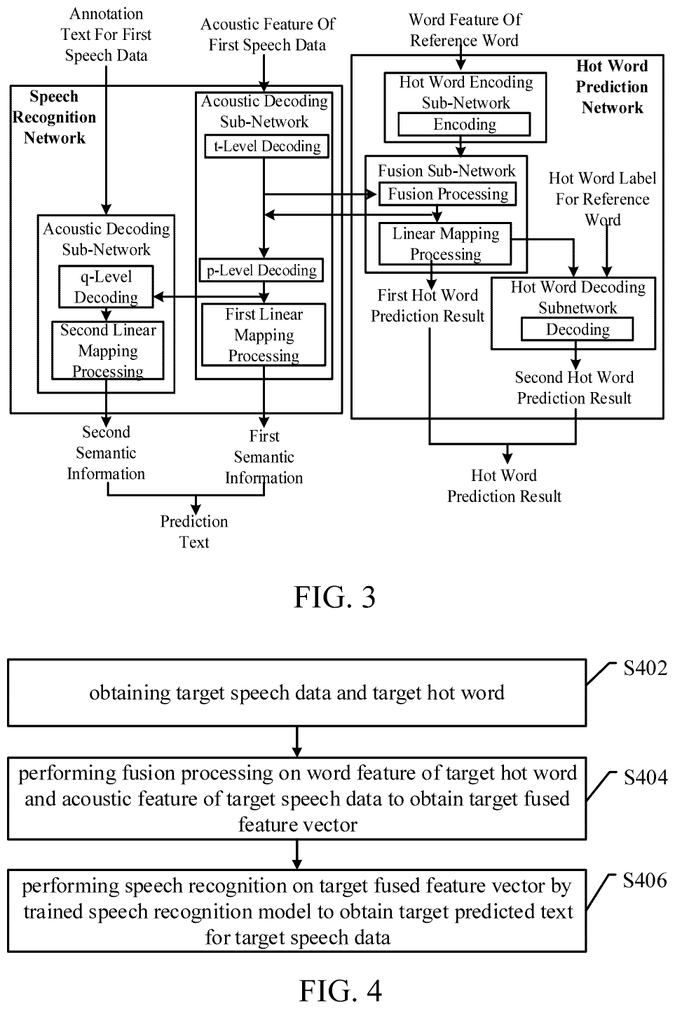

In practical applications, the multi-level encodings for the acoustic feature may be achieved through the speech recognition network of the speech recognition model. As an example, as shown in FIG. 3, the speech recognition network includes an acoustic encoding sub-network through which the conformer layer of the acoustic feature is t-level encoded to obtain the first acoustic representation vectors for the t levels, where t is an integer greater than 1.

The encoding and fusion for the word feature may be realized by the hot word prediction network of the speech recognition model. As an example, as shown in FIG. 3, the hot word prediction network includes a hot word encoding sub-network and a fusion sub-network, the word feature is input to the hot word encoding sub-network, and then is s-level encoded through the transformer layer of the hot word encoding sub-network to obtain the word representation vector. Where s is a positive integer. Then, the fusion processing is performed on the word representation vector and the t-th level first acoustic representation vector through the fusion sub-network to obtain the fused feature vector.

It should be noted that in the fusion method, the fusion processing is performed on the t-th level first acoustic representation vector and the word representation vector. The fusion processing may be performed according to the embodiment of Steps S141 to S145, or the fusion processing may be performed directly based on the attention mechanism, or the fusion processing may be performed according to the concatenating method, or the like.

At Step S106, the hot word prediction is performed based on the fused feature vector by using the speech recognition model to obtain a hot word prediction result for the first speech data, and the speech recognition is performed based on the fused feature vector to obtain a predicted text for the first speech data.

The hot word prediction result may be obtained by performing hot word prediction based on the fused feature in various ways. As an example, the fused feature vector may be subjected to linear mapping processing by the speech recognition model to obtain the hot word prediction result for the first speech data. As another example, the first hot word prediction result may be obtained by performing linear mapping processing on the fused feature vector based on the CTC mechanism through the speech recognition model, and the second hot word prediction result may be obtained by performing linear mapping processing on the fused feature vector based on the linear mapping mechanism of softmax. Finally, the final hot word prediction result is determined based on the first hot word prediction result and the second hot word prediction result. The hot word prediction result may include a probability that the reference word belongs to the hot word.

In practical application, the hot word prediction result may be obtained by hot word prediction of the fusion feature through the hot word prediction network of the speech recognition model. As an example, as shown in FIG. 3, the hot word prediction network includes not only a hot word encoding sub-network and a fusion sub-network, but also includes a fusion sub-network and a hot word decoding sub-network. The word features of the reference word two-level encoded through the transformer layer of the hot word encoding sub-network to obtain the word representation vector. The fusion processing is performed on the first acoustic representation vector at the t-th level and the word representation vector by a fusion sub-network to obtain the fused feature vector, and the linear mapping processing is performed on the fused feature vector by the CTC mechanism to obtain the first hot word prediction result. Multi-level decodings are performed on the fused feature vector based on the hot word label for the reference word by using the transformer layer of the hot word decoding sub-network, and the linear mapping processing is performed on the decoding result based on the linear mapping mechanism of softmax to obtain the second hot word prediction result. Finally, the final hot word prediction result is determined based on the first hot word prediction result and the second hot word prediction result.

The predicted text may be obtained by the speech recognition based on the fused feature vectors in various ways. As an example, the fused feature vector is subjected to the linear mapping process to obtain the predicted text. As another example, in a case where the fused feature vector is obtained by performing the fusion processing on the first target acoustic representation vector and the word representation vector, the fused feature vector is multi-level encoded to obtain a second acoustic representation vector for each level encoding. The speech recognition is performed based on the second target acoustic representation vector to obtain the predicted text for the first speech data. The second target acoustic representation vector is a second acoustic representation vector for the target level encoding of the multi-level encodings satisfying the second selection condition. The second selection condition may be set according to actual requirements, for example, the last level encoding is selected as the target-level encoding, and the second acoustic representation vector encoded by the last level encoding is used as the second target acoustic representation vector. The embodiment of the present disclosure is not limited thereto.

More specifically, the first linear mapping process is performed on the second target acoustic representation vector to obtain the first semantic information. The second target acoustic representation vector is decoded to obtain the semantic vector. The second linear mapping processing is performed on the semantic vector to obtain the second semantic information. The speech recognition is performed based on the first semantic information and the second semantic information to obtain the predicted text for the first speech data.

It will be appreciated that the multilevel encoding for the fused feature vector is similar to the modeling of the acoustic model from speech to text, and the acoustic mapping from speech to text is achieved. Therefore, the second acoustic representation vector for each level encoding implies a mapping relationship between speech and text. Then, the second target acoustic representation vector is selected from the second acoustic representation vectors, the first linear mapping process is performed on the second target acoustic representation vector, and the second target acoustic representation vector may be mapped to the first semantic information at a higher level. The decoding for the second target acoustic representation vector is similar to a language model predicting the next character by the previous n characters, and the obtained semantic vector carries richer semantic information. On this basis, the second target acoustic representation vector is subjected to the second linear mapping process, so that the second semantic information of the higher level may be obtained by mapping, and the semantics implied in the second semantic information is richer than the semantics implied in the first semantic information, thereby facilitating recognition of homophonic characters and reducing the probability of recognition errors of the homophonic characters. Therefore, the speech recognition is performed based on the first semantic information and the second semantic information, and the obtained predicted text is more accurate.

In practical application, the predicted text may be obtained by performing the speech recognition on the fusion feature through the speech recognition network of the speech recognition model. As an example, as shown in FIG. 3, the speech recognition network includes an acoustic decoding sub-network, in addition to an acoustic encoding sub-network. The acoustic encoding sub-network performs p-level encodings on the fusion feature through the conformer layer to obtain second acoustic representation vectors respectively for the p levels, and performs the first linear mapping processing on the p-th second acoustic representation vector as the second target acoustic representation vector based on the CTC mechanism to obtain first semantic information. Where p is an integer greater than 1. The acoustic decoding sub-network performs q-level decodings on the p-th level of the second acoustic representation vector based on the annotation text for the first speech data through the transformer layer to obtain the semantic vector, and performs second linear mapping processing on the semantic vector to obtain the second semantic information. Finally, the first speech information and the second semantic information are subjected to the weighted fusion and then the speech recognition to obtain the predicted text for the first speech data.

At Step S108, the speech recognition model is trained based on the hot word prediction result, the hot word label, and the predicted text for the first speech data.

In one or more embodiments, Step S108 includes: determining a first prediction loss of the hot word prediction network based on the hot word prediction result and the hot word label for the first speech data; determining a second prediction loss of the speech recognition network based on the predicted text for the first speech data and the annotation text for the first speech data; and updating the network parameters of the hot word prediction network and the network parameters of the speech recognition network based on the first prediction loss and the second prediction loss.

In another embodiment, the speech recognition network may be pre-trained, followed by fine adjusting of the hot word prediction network to achieve the training effect of the speech recognition model. Specifically, the speech recognition network is a trained network, such as a trained network pre-trained based on the second speech data and the annotation text for the second speech data. In this case, Step S108 includes: determining a first prediction loss of the hot word prediction network based on the hot word prediction result and the hot word label; determining a second prediction loss of the speech recognition network based on the predicted text for the first speech data and the annotation text for the first speech data; and performing fine adjustment on the network parameters of the hot word prediction network based on the first prediction loss and the second prediction loss, with network parameters of the speech recognition network frozen.

In practical applications, the second speech data may be part of the speech data extracted from the speech data set, or may be other speech data than the speech data set.

The first prediction loss may include a prediction loss caused by two types of linear mapping processes, i.e., a prediction loss caused by performing a first linear mapping process on the p-th level second acoustic representation vector (referred to as a first CTC loss) and a prediction loss caused by performing a second linear mapping process on the semantic vector (referred to as a first attention loss), as shown in FIG. 3. The first CTC loss may be calculated based on a difference between the reference semantic information of the annotation text for the first speech data and the first semantic information, and the first attention loss may be calculated based on a difference between the reference semantic information of the annotation text for the first speech data and the second semantic information.

Similarly, the second prediction loss may include a prediction loss caused by two types of linear mapping processing, i.e., a prediction loss caused by performing the linear mapping processing on the fused feature vector (referred to as the second CTC loss) and a prediction loss caused by performing the linear mapping on the decoding result of the fused feature vector (referred to as the second attention loss), as shown in FIG. 3. The second CTC loss may be calculated based on the difference between the hot word label for the reference word and the first hot word prediction result, and the second attention loss may be calculated based on the difference between the hot word label for the reference word and the second hot word prediction result.

In addition, in the training process, an improved Adaptive Moment Estimation (Adam) optimizer may be used. When the parameter update is performed, an L2 regularization term is newly added, and an L2 regularization term added when the gradient updates in the original Adam is removed. In this way, when the gradient changes, the violent parameter oscillation caused by the gradient change becomes smaller, and the training speed of the speech recognition and the model optimization effect are improved. In this manner, the L2 regularization term is added only when the parameter update is finally performed. In the original Adam, the L2 regularization term is added upon the gradient updates, so that the gradients are accumulated together, and the regularization function is infinitely amplified, so that the parameter oscillation is relatively violent. However, in the conventional scheme, the regularization term is not added when each gradient updates, and the regularization is performed only when the final parameter update in this round is performed, so that the regularization term may be better served for the parameter update, thereby reducing the violent parameter oscillation, and improving the speed and effect of the optimization.

In the above-described embodiment, the speech recognition network is pre-trained, then the network parameters of the speech recognition network are frozen, and the network parameters of the hot word prediction network are finely adjusted, so that the network parameters of each network in the speech recognition model are more stable, and the problem that the training oscillation easily occurs due to the addition of the reference word and the hot word label is prevented. In addition, the over-fitting phenomenon may be reduced, and the guiding effect of the reference word and the hot word label on the hot word capturing capability of the speech recognition model may be enhanced.

Note that the above-mentioned Step S102 to Step S108 is only one round of model training. In the actual training process, the speech recognition model is subjected to a plurality of rounds of training, that is, the foregoing Step S102 to Step S108 are executed for a plurality of times until the training stop condition is satisfied, and the speech recognition model after the last round of training is used as the final speech recognition model. The training stop condition may be set according to actual requirements, for example, including but not limited to the training times reaching the preset times threshold, or the weighting and convergence of the first prediction loss and the second prediction loss.

In the method of training the speech recognition model according to one or more embodiments of the present disclosure, a reference word for first speech data and a hot word label for the reference word are determined, to instruct the speech recognition model to capture similar hot word information as much as possible. The recognition effect may be improved even when the training data does not include the hot word to be recognized in an application scenario, thereby improving the hot word capturing capability of the speech recognition model in an unknown scenario. Then, the word feature of the reference word and the acoustic feature of the first speech data are fused so that the hot word information of the first speech data and the acoustic feature are effectively fused in the fused feature vector. On this basis, by the speech recognition model, the hot word prediction is performed based on the fused feature vector to obtain a hot word prediction result for the first speech data, and the speech recognition is performed based on the fused feature vector to obtain the predicted text for the first speech data. The speech recognition model is trained based on the hot word prediction result, the hot word label, and the predicted text for the first speech data. Therefore, it not only helps to improve the ability of the speech recognition model to pay attention to the hot word information in the first speech data to make the speech recognition model learn how to combine the acoustic features to capture the hot word information in the unknown scenario in the training process, but also makes the speech recognition model able to apply the captured hot word information to the speech recognition, to have the ability to accurately capture the hot words from the speech data, and to improve the accuracy of speech recognition.

One or more embodiments of the present disclosure further provides a speech recognition method based on the speech recognition model trained by the training method of the speech recognition model. FIG. 4 is a schematic flow diagram of a speech recognition method according to one or more embodiments of the present disclosure. The method includes Step S402 to Step S406.

At Step S402, target speech data and target hot words are obtained.

The target hot word may be set according to a specific application scenario, which is not limited to the presented embodiments of the present disclosure. For example, in an anti-fraud scenario, the target hot word may include, but are not limited to, words such as “fraud”, “low interest”, “fast money transfer”, unsecured” and so on.

At Step S404, fusion processing is performed on a word feature of the target hot word and an acoustic feature of the target speech data to obtain a target fused feature vector.

The specific embodiments of the above-mentioned Step S404 is similar to the specific embodiments of the Step S104 in the above-mentioned embodiments shown in FIG. 1, and will not be described repeatedly.

At Step S406, the speech recognition is performed on the target fused feature vector by the speech recognition model to obtain the predicted text for the target speech data.

The specific embodiments of Step S406 is similar to the specific embodiments of Step S106 in the embodiments shown in FIG. 1, and details are not described repeatedly.

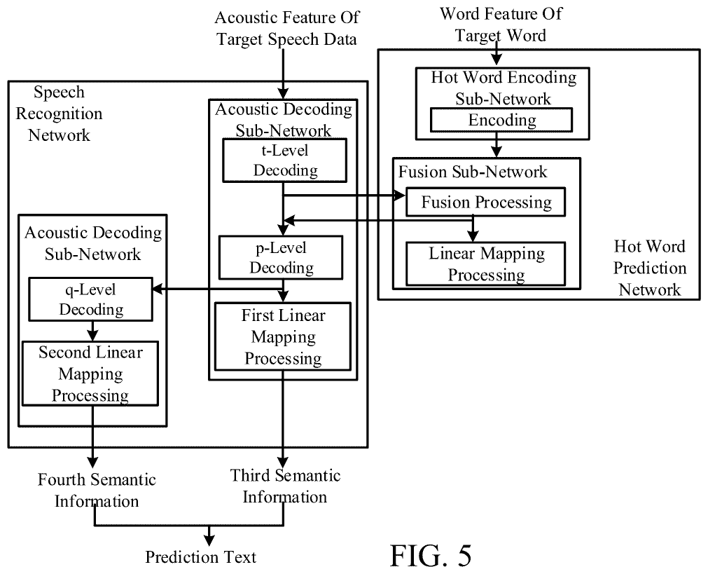

As an example, as shown in FIG. 5, the word feature of the target hot word is two-level encoded by the transformer layer of the hot word encoding sub-network to obtain the word representation vector, and the acoustic feature of the target speech data is t-level encoded by the conformer layer of the acoustic encoding sub-network to obtain the t-level third acoustic representation vectors. Then, the fusion processing is performed on the t-th level third acoustic representation vectors and the word representation vector by the fusion sub-network to obtain the target fused feature vector. Further, the target fused feature vector is p-level encoded by the conformer layer of the acoustic encoding sub-network to obtain the p-level fourth acoustic representation vectors. Further, the first linear mapping processing is performed on the p-th fourth acoustic representation vector based on the CTC mechanism to obtain the third semantic information, the q-level decodings are performed on the p-th fourth acoustic representation vector through the acoustic decoding sub-network to obtain the semantic vector. The second linear mapping processing is performed on the semantic vector to obtain the fourth semantic information. Finally, the third semantic information and the fourth semantic information is subjected to the weighted fusion and then the speech recognition to obtain the predicted text for the target speech data.

According to the speech recognition method according to one or more embodiments of the present disclosure, the acoustic feature of the target speech data and the word feature of the target hot word are fused so that the acoustic feature and the hot word information are effectively fused in the target fused feature vector. On this basis, since the trained speech recognition model has the hot word capturing ability and the ability to apply the captured hot word information to the speech recognition process, the target fused feature vector is speech recognized by the speech recognition model, so that the hot word information in the target speech data may be accurately captured, and the output predicted text is more accurate.

Some embodiments of this specification have been described above. Other embodiments are within the scope of the appended claims. In some cases, the operations or steps recited in the claims may be performed in an order different from that in the embodiments but the desired results may still be achieved. In addition, the processes depicted in the drawings do not necessarily require the particular order or sequential order shown to achieve the desired results. In certain embodiments, multitasking and parallel processing are also possible or may be advantageous.

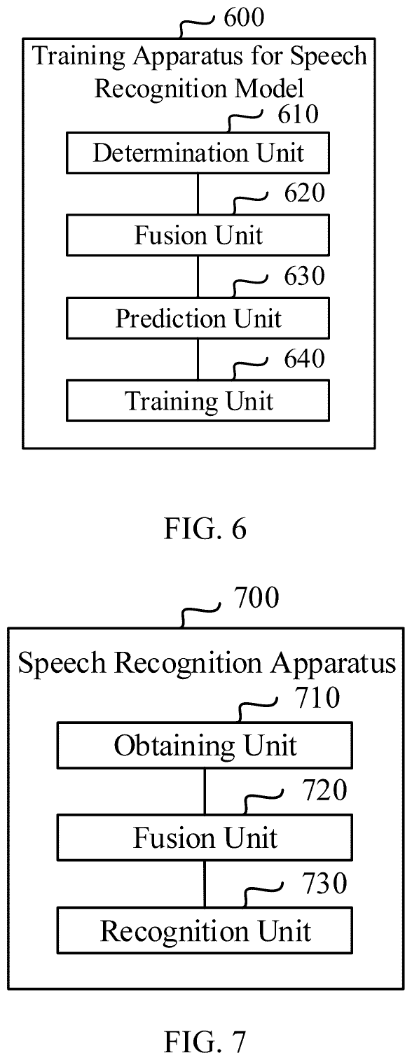

Based on the same inventive concept, one or more embodiments of the present disclosure further provides an apparatus for training the speech recognition model. Referring to FIG. 6, FIG. 6 is a schematic block diagram of the training apparatus 600 for the speech recognition model according to one or more embodiments of the present disclosure, and the training apparatus 600 includes a determination unit 610, a fusion unit 620, a prediction unit 630, and a training unit 640.

The determination unit 610 is configured to determine a reference word for first speech data and a hot word label for the reference word.

The fusion unit 620 is configured to perform fusion processing on the word feature of the reference word and the acoustic feature of the first speech data to obtain a fused feature vector.

The prediction unit 630 is configured to perform hot word prediction on the fused feature vector by the speech recognition model to obtain a hot word prediction result for the first speech data, and configured to perform speech recognition on the fused feature vector to obtain predicted text for the first speech data.

The training unit 640 is configured to train the speech recognition model based on the hot word prediction result, the hot word label, and the predicted text for the first speech data.

In another embodiment, when performing the fusion processing on the word feature of the reference word and the acoustic feature of the first speech data to obtain the fused feature vector, the fusion unit performs the steps of:
performing a block attention operation on the word feature of the reference word and the acoustic feature of the first speech data to obtain an operation result; and
performing a cross attention operation based on the operation result to obtain the fused feature vector.

In another embodiment, when performing the block attention operation on the word feature of the reference word and the acoustic feature of the first speech data to obtain the operation result, the fusion unit performs the steps of:
determining a first query matrix based on the word feature of the reference word;
determining a first key matrix and a first value matrix based on the acoustic feature; and
performing the block attention operation based on the first query matrix, the first key matrix, and the first value matrix to obtain the operation result.

In another embodiment, when performing the block attention operation based on the first query matrix, the first key matrix, and the first value matrix to obtain the operation result, the fusion unit performs the following steps:
dividing the first query matrix into N sub-query matrices, where N is an integer greater than 1;
dividing the first key matrix into N sub-key matrices, and dividing the first value matrix into N sub-value matrices;
grouping the N sub-query matrices, the N sub-key matrices, and the N sub-value matrices to obtain M first matrix sets each including one of the sub-query matrices, one of the sub-key matrices, and one of the sub-value matrices, where M is an integer greater than N; and
for each first matrix set, performing the attention operation on the first matrix set to obtain a first attention feature of the first matrix set, and adding the respective first attention features to obtain the operation result.

In another embodiment, the operation result includes the first attention features of the M first matrix sets;

When performing the cross attention operation based on the operation result to obtain the fused feature vector, the fusion unit performs the following steps:
determining M second query matrices, M second key matrices, and M second value matrices based on the first attention features of the M first matrix sets;
grouping the M second query matrices, the M second key matrices, and the M second value matrices to obtain K second matrix sets each including one of the M second query matrices, one of the M second key matrices, and one of the M second value matrices, where K is an integer greater than M;
for each second matrix set, performing the cross attention operation on the second matrix set to obtain a second attention feature of the second matrix set; and
concatenating the second attention features of the K second matrix sets to obtain the fused feature vector.

In another embodiment, when performing the fusion processing on the word feature of the reference word and the acoustic feature of the first speech data to obtain the fused feature vector, the fusion unit performs the steps of:
encoding the word feature by the speech recognition model to obtain a word representation vector; and
performing multi-level encodings on the acoustic feature by the speech recognition model to obtain the first acoustic representation vector for each level encoding, and performing fusion processing on the first target acoustic representation vector and the word representation vector to obtain the fused feature vector. The first target acoustic representation vector is a first acoustic representation vector for the target level encoding of the multi-level encodings satisfying the first selection condition.

In another embodiment, when performing speech recognition on the fused feature vector to obtain predicted text for the first speech data, the prediction unit performs the steps of:
performing multi-level encodings on the fused feature vector to obtain a second acoustic representation vector for each level encoding; and
performing speech recognition based on the second target acoustic representation vector to obtain predicted text for the first speech data; the second target acoustic representation vector is a second acoustic representation vector for the target level encoding of the multi-level encodings satisfying the second selection condition.

In another embodiment, when performing the speech recognition based on the second target acoustic representation vector to obtain the predicted text for the first speech data, the prediction unit performs the steps of:
performing first linear mapping processing on the second target acoustic representation vector to obtain first semantic information; and
decoding the second target acoustic representation vector to obtain a semantic vector;
performing second linear mapping processing on the semantic vector to obtain second semantic information; and
performing speech recognition based on the first semantic information and the second semantic information to obtain the predicted text for the first speech data.

In another embodiment, the determination unit is configured to:
performing text extraction on the annotation text for the speech data included in the speech data set to obtain the reference word for the first speech data; and
determining a hot word label for the reference word based on the annotation text for the first speech data.

In another embodiment, when performing the text extraction on the annotation text for the speech data included in the speech data set to obtain the reference word for the first speech data, the determining unit performs the steps of:
randomly extracting one or more words from the annotation text for the speech data included in the speech data set as the reference word for the first speech data;

When determining the hot word label for the reference word based on the annotation text for the first speech data, the determining unit performs the following steps:
determining the hot word label for the reference word based on a matching state between the reference word and the one or more words in the annotation text for the first speech data.

In another embodiment, the speech recognition model includes a speech recognition network and a hot word prediction network, and the speech recognition network is a trained network.

When training the speech recognition model based on the hot word prediction result, the hot word label, and the predicted text, the training unit performs the following steps:
determining a first prediction loss of the hot word prediction network based on the hot word prediction result and the hot word label;
determining a second prediction loss of the speech recognition network based on the predicted text for the first speech data and the annotation text for the first speech data; and
performing fine adjustment on network parameters of the hot word prediction network based on the first prediction loss and the second prediction loss, with network parameters of the speech recognition network frozen.

The training apparatus of the speech recognition model according to one or more embodiments of the present disclosure can be used as an execution body of the training method of the speech recognition model shown in FIG. 1. For example, in the training method of the speech recognition model shown in FIG. 1, Step S102 may be executed by the determination unit 610 in the training apparatus of the speech recognition model shown in FIG. 6, Step S104 may be executed by the fusion unit 620 in the training apparatus of the speech recognition model shown in FIG. 6, Step S106 may be executed by the prediction unit 630 in the training apparatus of the speech recognition model shown in FIG. 6, and Step S108 may be executed by the training unit 640 in the training apparatus of the speech recognition model shown in FIG. 6.

According to another embodiment of the present disclosure, each of the units in the training apparatus of the speech recognition model shown in FIG. 6 may be separately or all combined into one or several additional units, or one or more of the units may be subdivided into a plurality of functionally smaller units, which may perform the same operation without affecting the implementation of the technical effect of the embodiment of the present disclosure. The above-mentioned units are divided based on logical functions. In practical applications, the functions of one unit may be implemented by a plurality of units, or the functions of a plurality of units may be implemented by one unit. In one or more embodiments of the present disclosure, the training apparatus of the speech recognition model may further include other units. In practical applications, these functions may be implemented with the assistance of other units, and may be implemented in cooperation with a plurality of units.

According to another embodiment of the present disclosure, the training apparatus of the speech recognition model shown in FIG. 6 may be constructed and the training method of the speech recognition model according to one or more embodiments of the present disclosure may be implemented, by running a computer program (including program code) capable of executing the steps involved in the corresponding method shown in FIG. 1 on a general-purpose computing device, such as a computer, including a processing element and a storage element such as a central processing unit (CPU), a random access memory (RAM), a read-only memory (ROM), and/or the like. The computer program may be recorded on, for example, a computer-readable storage medium and transferred to and executed in an electronic device by the computer-readable storage medium.

Based on the same inventive concept, one or more embodiments of the present disclosure further provides a speech recognition apparatus. Referring to FIG. 7, FIG. 7 is a schematic block diagram of a speech recognition apparatus 700 according to one or more embodiments of the present disclosure. The apparatus 700 includes an obtaining unit 710, a fusion unit 720, and a recognition unit 730.

The obtaining unit 710 is configured to obtain target speech data and target hot word.

The fusion unit 720 is configured to perform fusion processing on the word feature of the target hot word and the acoustic feature of the target speech data to obtain a target fused feature vector.

The recognition unit 730 is configured to perform speech recognition on the target fused feature vector by the speech recognition model to obtain predicted text for the target speech data. The speech recognition model is obtained by training based on the training method of the speech recognition model according to one or more embodiments of the present disclosure.

The speech recognition apparatus according to one or more embodiments of the present disclosure may be used as the execution body of the speech recognition method shown in FIG. 4. For example, in the speech recognition method shown in FIG. 4, Step S402 may be performed by the obtaining unit 710 in the speech recognition apparatus shown in FIG. 7, Step S404 may be performed by the fusion unit 720 in the speech recognition apparatus shown in FIG. 7, and Step S406 may be performed by the recognition unit 730 in the speech recognition apparatus shown in FIG. 7.

According to another embodiment of the present disclosure, each of the units in the speech recognition apparatus shown in FIG. 7 may be separately or all combined into one or several additional units, or one or more of the units may be subdivided into a plurality of functionally smaller units, which may perform the same operation without affecting the implementation of the technical effect of the embodiment of the present disclosure. The above-mentioned units are divided based on logical functions. In practical applications, the functions of one unit may be implemented by a plurality of units, or the functions of a plurality of units may be implemented by a module. In one or more embodiments of the present disclosure, the speech recognition apparatus may further include other units. In practical applications, these functions may be implemented with the assistance of other units, and may be implemented in cooperation with a plurality of units.

According to another embodiment of the present disclosure, the speech recognition apparatus shown in FIG. 7 may be constructed and the speech recognition method according to one or more embodiments of the present disclosure may be implemented, by running a computer program (including program code) capable of executing the steps involved in the corresponding method shown in FIG. 4 on a general-purpose computing device, such as a computer, including a processing element and a storage element such as a central processing unit (CPU), a random access memory (RAM), a read-only memory (ROM), and/or the like. The computer program may be recorded on, for example, a computer-readable storage medium and transferred to and executed in an electronic device by the computer-readable storage medium.

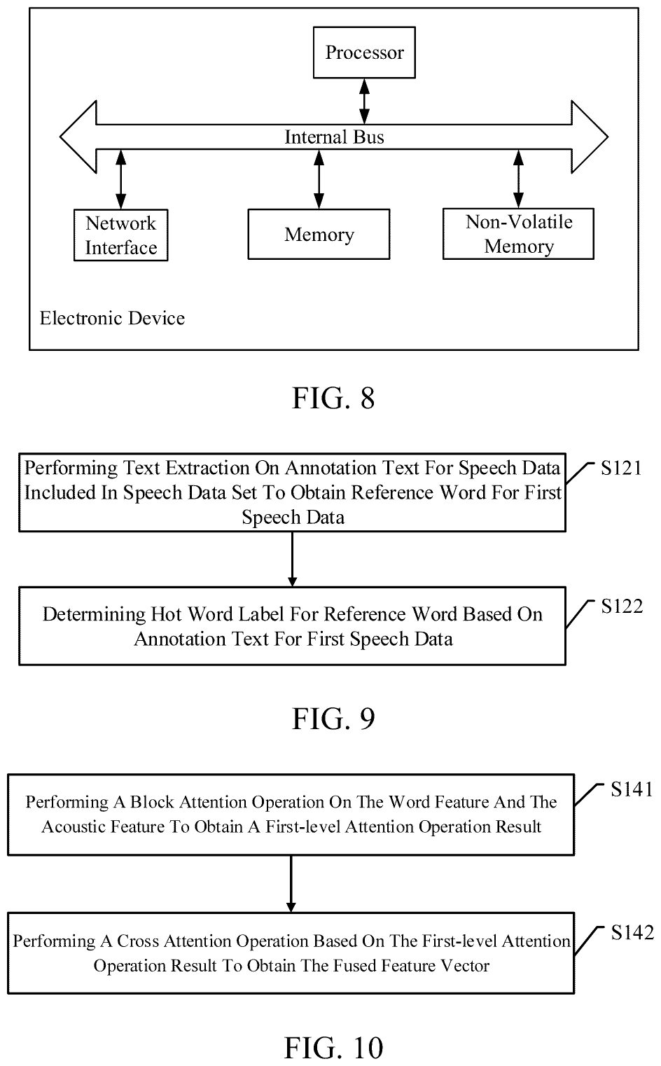

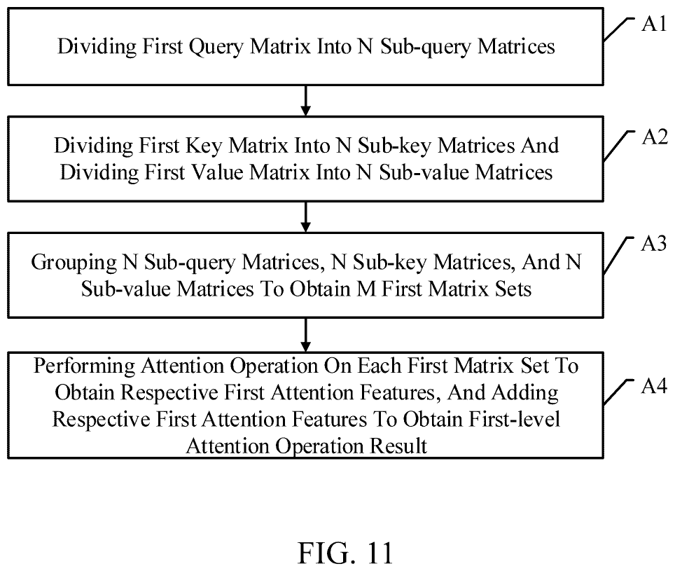

FIG. 8 is a schematic block diagram of an electronic device according to one or more embodiments of the present disclosure. Referring to FIG. 8, at the hardware level, the electronic device includes a processor. Alternatively, the electronic device further includes an internal bus, a network interface, and a storage device. The storage device may include a memory, such as a random-access memory (RAM), or may further include a non-volatile memory, such as at least one disk memory, etc. The electronic device may further include hardware required for other services.

The processor, the network interface, and the storage device may be interconnected by an internal bus, which may be an industry standard architecture (ISA) bus, a peripheral component interconnect (PCI) bus, or an extended industry standard architecture (EISA) bus, etc. The bus may be divided into an address bus, a data bus, a control bus, and/or the like. For ease of illustration, the bus is indicated by using only one bi-directional arrow shown in FIG. 8. However, it does not indicate that there is only one bus or one type of bus.

The storage device is configured to store the program. Specifically, the program may include program code including computer operation instructions. The storage device may include memory and non-volatile memory, and provides instructions and data to the processor.

The processor reads the corresponding computer program from the non-volatile memory to the memory, then runs the corresponding computer program, and forms training means for the speech recognition model at a logical level. The processor that executes the program stored in the storage device is configured to perform the following operations:
determining a reference word for first speech data and a hot word label for the reference word;
performing fusion processing on the word feature of the reference word and the acoustic feature of the first speech data to obtain a fused feature vector;
performing hot word prediction based on the fused feature vector by the speech recognition model to obtain a hot word prediction result for the first speech data, and performing speech recognition based on the fused feature vector to obtain predicted text for the first speech data; and
training the speech recognition model based on the hot word prediction result, the hot word label, and the predicted text.

Alternatively, the processor reads the corresponding computer program from the non-volatile memory to the memory and then runs the corresponding computer program to form the speech recognition device at the logical level. The processor that executes the program stored in the storage device is configured to perform the following operations:
obtaining target speech data and target hot word;
performing fusion processing on the word feature of the target hot word and the acoustic feature of the target speech data to obtain a target fused feature vector; and
performing speech recognition on the target fused feature vector by the speech recognition model to obtain the predicted text for the target speech data; the speech recognition model is obtained by training by using the training method of the speech recognition model according to the first aspect.

The method performed by the training apparatus of the speech recognition model disclosed in the embodiment shown in FIG. 1 of the present disclosure, or the method performed by the speech recognition apparatus disclosed in the embodiment shown in FIG. 4 of the present disclosure, may be applied to or implemented by a processor. The processor may be an integrated circuit chip having signal processing capabilities. In an implementation, the steps of the above method may be performed by integrated logic circuits of hardware in the processor or by instructions in the form of software. The processor may be a general-purpose processor, including a central processing unit (CPU), a network processor (NP), and the like. It may also be a digital signal processor (DSP), an application specific integrated circuit (ASIC), a field-programmable gate array (FPGA) or other programmable logic device, a discrete gate or transistor logic device, a discrete hardware component. The methods, steps, and logical block diagrams disclosed in the embodiments of the present disclosure may be implemented or performed. The general purpose processor may be a microprocessor or the processor may be any conventional processor or the like. The steps of the method disclosed in connection with the embodiment of the present disclosure may be directly performed by a hardware decoding processor, or performed by a combination of hardware and software modules in the decoding processor. The software module may be located in a storage medium mature in the art such as a random access memory, a flash memory, a read-only memory, a programmable read-only memory, or an electrically erasable programmable memory, a register, or the like. The storage medium is located in a storage device, and the processor reads information in the storage device and performs the steps of the above method in conjunction with its hardware.

The electronic device may also perform the method of FIG. 1, and implement the functions of the training apparatus of the speech recognition model in the embodiments shown in FIGS. 1, 2, and 3. Alternatively, the electronic device may perform the method of FIG. 4, and implement the functions of the speech recognition apparatus in the embodiments shown in FIGS. 4 and 5. Details of the embodiments of the present disclosure are not described herein.

The electronic device of the present disclosure may have other implementations other than a software implementation, such as a logic device or a combination of software and hardware, which means that the execution body of the following process flow is not limited to the respective logic unit, but may be hardware or a logic device.

One or more embodiments of the present disclosure further provides a computer-readable storage medium storing one or more programs including instructions that, when executed by a portable electronic device including a plurality of application programs, enable the portable electronic device to perform the method of the embodiment shown in FIG. 1, and specifically for performing the following operations:
determining a reference word for first speech data and a hot word label for the reference word;
performing fusion processing on the word feature of the reference word and the acoustic feature of the first speech data to obtain a fused feature vector;
performing hot word prediction based on the fused feature vector by the speech recognition model to obtain a hot word prediction result for the first speech data, and performing speech recognition based on the fused feature vector to obtain predicted text for the first speech data; and
training the speech recognition model based on the hot word prediction result, the hot word label, and the predicted text.

Alternatively, the instruction, when executed by a portable electronic device including a plurality of application programs, enables the portable electronic device to perform the method of the embodiment shown in FIG. 1, and specifically to perform the following operations:
obtaining target speech data and target hot word;
performing fusion processing on the word feature of the target hot word and the acoustic feature of the target speech data to obtain a target fused feature vector; and
performing speech recognition on the target fused feature vector by the speech recognition model to obtain the predicted text for the target speech data; the speech recognition model is obtained by training by using the training method of the speech recognition model according to the first aspect.

One or more embodiments of the present disclosure also provide a computer program product including a non-transitory computer-readable storage medium storing a computer program executable by a computer to perform some or all of the steps in the training method or the speech recognition method of the speech recognition model according to some embodiments of the present disclosure.

In sum, the foregoing description is only a preferred embodiment of the present disclosure and is not intended to limit the scope of the present disclosure. Any modifications, equivalents, improvements, etc. which fall within the spirit and principles of the present disclosure are intended to be included within the scope of the present disclosure.

The system, apparatus, module or unit set forth in the above embodiments may be embodied by a computer chip or entity or by a product having a certain function. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

Computer-readable media, including permanent and non-permanent, removable and non-removable media, may be implemented for information storage by any method or technique. The information may be computer-readable instructions, data structures, modules of a program, or other data. Examples of storage media for computers include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disks (DVD) or other optical storage, magnetic cassette tape, magnetic disk storage or other magnetic storage devices, or any other non-transmission medium that can be used to store information that can be accessed by a computing device. As defined herein, a computer-readable medium does not include a transitory media, such as modulated data signals and carrier waves.

It is also noted that the terms “comprises,” “comprising,” or any other variation thereof, are intended to cover a non-exclusive inclusion, such that a process, method, article, or apparatus that comprises a list of elements includes not only those elements but also other elements not expressly listed, or also includes elements inherent to such process, method, article, or apparatus. Without more limitations, elements defined by the statement “include a . . . ” do not exclude additional identical elements included in the process, method, article, or apparatus including the elements.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. A method of training a model, comprising:
determining a reference word for first speech data and a hot word label for the reference word;
performing fusion processing on a word feature of the reference word and an acoustic feature of the first speech data to obtain a fused feature vector;
performing, by the model, hot word prediction based on the fused feature vector to obtain a hot word prediction result for the first speech data;
performing, by the model, speech recognition based on the fused feature vector to obtain a predicted text for the first speech data; and
training the model based on the hot word prediction result, the hot word label, and the predicted text.

2. The method of claim 1, wherein the performing of the fusion processing on the word feature and the acoustic feature to obtain the fused feature vector comprises:
using a block attention operation on the word feature and the acoustic feature to obtain an operation result; and
performing a cross attention operation based on the operation result to obtain the fused feature vector.

3. The method of claim 2, wherein the performing of the block attention operation on the word feature and the acoustic feature to obtain the operation result comprises:
determining a first query matrix based on the word feature;
determining a first key matrix and a first value matrix based on the acoustic feature; and
performing the block attention operation based on the first query matrix, the first key matrix, and the first value matrix to obtain the operation result.

4. The method of claim 3, wherein the performing of the block attention operation based on the first query matrix, the first key matrix, and the first value matrix to obtain the operation result comprises:
dividing the first query matrix into N sub-query matrices, dividing the first key matrix into N sub-key matrices, and dividing the first value matrix into N sub-value matrices, where Nis an integer greater than 1;
grouping the N sub-query matrices, the N sub-key matrices, and the N sub-value matrices to obtain M first matrix sets each comprising one of the N sub-query matrices, one of the N sub-key matrices, and one of the N sub-value matrices, where M is an integer greater than N; and
performing an attention operation on each of the M first matrix sets to obtain respective first attention features of the M first matrix sets, and adding the respective first attention features to obtain the operation result.

5. The method of claim 4, wherein the performing of the cross attention operation based on the operation result to obtain the fused feature vector comprises:
determining M second query matrices, M second key matrices, and M second value matrices based on the respective first attention features of the M first matrix sets;
grouping the M second query matrices, the M second key matrices, and the M second value matrices to obtain K second matrix sets each comprising one of the M second query matrices, one of the M second key matrices, and one of the M second value matrices, where K is an integer greater than M;
performing the cross attention operation on each of the K second matrix sets to obtain respective second attention features of the K second matrix sets; and
concatenating the second attention features of the K second matrix sets to obtain the fused feature vector.

6. The method of claim 1, wherein the performing of the fusion processing on the word feature and the acoustic feature to obtain the fused feature vector comprises:
encoding the word feature by the model to obtain a word representation vector;
performing multi-level first encoding on the acoustic feature by the model to obtain a plurality of first acoustic representation vectors respectively corresponding to a plurality of levels of the first encoding; and
performing fusion processing on a first target acoustic representation vector and the word representation vector to obtain the fused feature vector, wherein the first target acoustic representation vector is one of the first acoustic representation vectors corresponding to a target one of the levels of the first encoding satisfying a first selection condition.

7. The method of claim 6, wherein the performing of the speech recognition based on the fused feature vector to obtain the predicted text for the first speech data comprises:
performing multi-level second encoding on the fused feature vector to obtain a plurality of second acoustic representation vectors respectively corresponding to a plurality of levels of the second encoding; and
performing the speech recognition based on a second target acoustic representation vector to obtain the predicted text for the first speech data, wherein the second target acoustic representation vector is one of the second acoustic representation vectors corresponding to a target one of the levels of the second encoding satisfying a second selection condition.

8. The method of claim 7, wherein the performing of the speech recognition based on the second target acoustic representation vector to obtain the predicted text for the first speech data comprises:
performing first linear mapping processing on the second target acoustic representation vector to obtain first semantic information;
decoding the second target acoustic representation vector to obtain a semantic vector;
performing second linear mapping processing on the semantic vector to obtain second semantic information; and
performing the speech recognition based on the first semantic information and the second semantic information to obtain the predicted text for the first speech data.

9. The method of claim 1, wherein the determining of the reference word for the first speech data and the hot word label for the reference word comprises:
performing text extraction on an annotation text for speech data included in a speech data set to obtain the reference word for the first speech data; and
determining the hot word label for the reference word based on an annotation text for the first speech data.

10. The method of claim 9, wherein the performing of the text extraction on the annotation text for the speech data included in the speech data set comprises: randomly extracting a word from the annotation text for the speech data included in the speech data set, as the reference word for the first speech data; and
the determining of the hot word label for the reference word based on the annotation text for the first speech data comprises: determining the hot word label for the reference word based on whether the reference word matches a word in the annotation text for the first speech data.

11. The method of claim 1, wherein the model comprises a speech recognition network and a hot word prediction network, and the speech recognition network is a trained network; and
the training of the model based on the hot word prediction result, the hot word label, and the predicted text comprises:
determining a first prediction loss of the hot word prediction network based on the hot word prediction result and the hot word label;
determining a second prediction loss of the speech recognition network based on the predicted text for the first speech data and an annotation text for the first speech data; and
performing fine adjustment on network parameters of the hot word prediction network based on the first prediction loss and the second prediction loss, with network parameters of the speech recognition network frozen.

12. A speech recognition method comprising:
obtaining target speech data and a target hot word;
performing fusion processing on a word feature of the target hot word and an acoustic feature of the target speech data to obtain a target fused feature vector; and
performing speech recognition on the target fused feature vector by a trained model to obtain a target predicted text for the target speech data,
wherein the trained model is obtained by:
determining a reference word for first speech data and a hot word label for the reference word;
performing fusion processing on a word feature of the reference word and an acoustic feature of the first speech data to obtain a fused feature vector;
performing, by a model, hot word prediction based on the fused feature vector to obtain a hot word prediction result for the first speech data;
performing, by the model, speech recognition based on the fused feature vector to obtain a predicted text for the first speech data; and
training the model based on the hot word prediction result, the hot word label, and the predicted text for the first speech data.

13. An electronic device comprising:
a processor; and
a memory storing instructions executable by the processor to perform operations comprising:
determining a reference word for first speech data and a hot word label for the reference word;
performing fusion processing on a word feature of the reference word and an acoustic feature of the first speech data to obtain a fused feature vector;
performing, by a model, hot word prediction based on the fused feature vector to obtain a hot word prediction result for the first speech data;
performing, by the model, speech recognition based on the fused feature vector to obtain a predicted text for the first speech data; and
training the model based on the hot word prediction result, the hot word label, and the predicted text for the first speech data.

14. The electronic device of claim 13, wherein the performing of the fusion processing on the word feature and the acoustic feature to obtain the fused feature vector comprises:
performing a block attention operation on the word feature and the acoustic feature to obtain an operation result; and
performing a cross attention operation based on the operation result to obtain the fused feature vector.

15. The electronic device of claim 14, wherein the performing of the block attention operation on the word feature and the acoustic feature to obtain the operation result comprises:
determining a first query matrix based on the word feature;
determining a first key matrix and a first value matrix based on the acoustic feature; and
performing the block attention operation based on the first query matrix, the first key matrix, and the first value matrix to obtain the operation result.

16. An electronic device comprising:
a processor; and
a memory storing instructions executable by the processor to perform the speech recognition method of claim 12.

17. A non-transitory computer-readable storage medium storing instructions executable by a processor of an electronic device to perform the method of claim 1.

18. A non-transitory computer-readable storage medium storing instructions executable by a processor of an electronic device to perform the speech recognition method of claims 12.

19. A computer program product, comprising a non-transitory computer-readable storage medium storing a computer program executable by a computer to perform the method of claim 1.

20. A computer program product, comprising a non-transitory computer-readable storage medium storing a computer program executable by a computer to perform the speech recognition method of claim 12.
